(19) United States
(12) Patent Application Publication
(10) Pub. No.: US 2010/0176067 A1
(43) Pub. Date: Jul. 15, 2010

(54) Photocatalytic reactor and process for photocatalysis

(76) Inventors: Joel E. Boyd, Plainview, TX (US); Luke H. Loetscher, Cheyenne, WY (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 12/589,834

(22) Filed: Oct. 29, 2009

Related U.S. Application Data
(60) Provisional application No. 61/197,855, filed on Oct. 31, 2008.

(51) Int. Cl. C02F 1/32; B01J 19/12

(52) U.S. Cl. 210/748.09; 422/186.3

(57) ABSTRACT

A coil-shaped reactor and process are provided to degrade or remove contaminants from water.

This application claims the benefit of U.S. Provisional Patent Application Ser. No. 61/197,855, filed Oct. 31, 2008.

### TECHNICAL FIELD

The present invention relates to photocatalysis. In a more specific aspect, the present invention relates to a coil-shaped reactor for photocatalysis. (The reactor of this invention can be referred to as a “photocatalytic reactor”.)

The present invention also relates to a process for photocatalysis which occurs in a coil-shaped photocatalytic reactor.

This invention will be described with specific reference to titanium dioxide (also referred to as titania) as the photocatalyst and to an acrylic material as the polymeric material. However, this invention should be understood as applicable to other catalysts and polymeric materials, as will be described in this application.

### BACKGROUND OF THE INVENTION

In general terms, a catalyst is a substance which increases the rate of the reaction being catalyzed without being consumed in the reaction. Stated another way, catalysis is the acceleration of a reaction in the presence of a catalyst.

The activation of a catalyst is sometimes achieved through the absorption of light. A catalyst activated by the absorption of light is termed a photocatalyst.

Titanium dioxide (titania) photocatalysis is a promising technology for water purification and sterilization, but one that has not yet fully made the transition from the laboratory to commercial or industrial application. The barriers to this transition have historically involved limitations of the illumination sources utilized, the photocatalytic materials themselves, titania deposition techniques and reactor designs. Fortunately, there has been considerable progress in many of these areas. Recent advances in photocatalytic materials and illumination sources now provide a platform for further development of photocatalytic reactors for water purification.

An efficient photocatalytic reactor demands an effective illumination source. Desirable traits for a light source for photocatalytic applications include high intensity, high energy efficiency, appropriate wavelength and ruggedness coupled with a long useful lifetime. In recent years, two light sources have emerged that fulfill these requirements: compact fluorescent blacklights (CFLs) and ultraviolet light emitting diodes (LEDs). Several reports have been published utilizing each of these light sources for photocatalytic applications. CFLs are advantagueous as compared to UV-LEDs in that their intensity is typically much greater, and their cost is significantly lower. UV-LEDs are extremely energy efficient and are advantageous as compared to CFLs in that the utilization of direct current (DC) power enhances their attractiveness for portable photocatalytic systems, and they do not contain mercury (Hg) as most CFLs do. LEDs are also more rugged, further increasing their attractiveness for portable applications. Typical lifetimes for CFLs are 2000 hours, whereas UV-LEDs can have expected lifetimes exceeding 100,000 hours.

Water contaminants can be divided into three main categories: organic, inorganic and microbiological. A benefit of titania photocatalysis for water purification is the ability to simultaneously address all of these types of contaminants. This benefit is in contrast to many other water purification approaches that require a combination of multiple techniques to achieve successful degradation of all three types of contamination. Additionally, there is minimal risk of the production of harmful byproducts with titania photocatalytic water purification.

Titania (titanium dioxide) acts photocatalytically by absorbing UV light (λ<400 nm) to generate electron-hole pairs. These separated electrons and holes are then available to drive reduction and oxidation reactions respectively if electron-hole recombination is avoided. Degussa P-25 is a commonly used benchmark titania material that is comprised of 80% anatase and 20% rutile with a mean particle size of 30 nm. The utilization of titania nanoparticles inherently controls the extent of electron-hole recombination due to the ratio of particle surface to particle volume at the nanoscale. However, the use of nanoparticulate photocatalysts necessitates the deposition of the photocatalyst on a macroscopic support to avoid the need for postphotocatalytic filtration to remove the photocatalyst.

Therefore, there is a need in the industry for a reactor in which a durable, photocatalytically active composite material of titanium dioxide (titania) deposited on an ultraviolet light support can be effectively used.

### SUMMARY OF THE INVENTION

Briefly described, the present invention provides a coil-shaped photocatalytic reactor for removing contaminants from water.

The present invention also provides a process for the removal of contaminants from water, wherein the process comprises moving the water through a coil-shaped photocatalytic reactor.

When used in this application, the term “catalytic”, “catalysis” and “catalyst” will be understood to include photocatalytic, photocatalysis, and photocatalyst, respectively.

### BRIEF DESCRIPTION OF THE DRAWINGS

FIG. 1A shows a preferred embodiment of a coil-shaped reactor according to the present invention.

FIGS. 1B-1E show alternative views of the preferred embodiment shown in FIG. 1A. In FIG. 1E, the 275.00 refers to a dimension of 275.00 mm or 27.5 cm.

FIG. 1F shows a core/lid structure used in a coil-shaped reactor of this invention with a light emitting diode (LED) as a source of ultraviolet light, in which the light emitting diode (LED) is placed on top of the core/lid structure with the illumination directed downward toward a reflective core.

FIG. 1G also shows a core/lid structure used in a coil-shaped reactor of the present invention with a compact fluorescent blacklight (CFL) as a source of ultraviolet light, in which the compact fluorescent blacklight (CFL) is placed inverted into the core/lid structure.

FIG. 2 shows a normalized irradiance spectra from the CFL and LED ultraviolet light sources graphed using the left axis with the absorbance spectra of 10 ppm methyl orange (MO) and 10 ppm methylene blue (MB) graphed using the right axis.

FIG. 3 shows the degradation rate of methyl orange as a function of the irradiance provided to a 9 cm diameter round titania-acrylic disk in contact with a 20 ppm methyl orange solution.

FIG. 4A shows the degradation of methylene blue with CFL and LED ultraviolet light sources, along with light and dark controls.

FIG. 4B shows the degradation of methyl orange with CFL and LED ultraviolet light sources, along with light and dark controls.

FIG. 4C shows the pseudo-first order rate constants determined from the slopes shown in FIGS. 4A and 4B, in which the error bars represent one standard deviation calculated from the triplicate experiments shown in FIGS. 4A and 4B.

FIG. 5 shows the full degradation of 10 ppm methylene blue and 10 ppm methyl orange solutions over an exposure time of 400 minutes using a CFL as the ultraviolet light source.

FIG. 6A shows the degradation of bacteria in a titania-coated reactor of this invention and in a control reactor, in which both reactors use a CFL as the ultraviolet light source.

FIG. 6B shows the degradation of bacteria in a titania-coated reactor of this invention and in a control reactor, in which both reactors use LED as the ultraviolet light source. The error bars represent one standard deviation calculated from the triplicate experiments shown in FIGS. 6A and 6B.

FIG. 7A shows the concentration of lead (Pb) in solution as a function of time using a CFL as the ultraviolet light source. The error bars represent one standard deviation calculated from triplicate experiments.

FIG. 7B shows the percentage of lead (Pb) removed from 20 ppm Pb solutions in six consecutive experiments.

Except where specifically noted, the above Figures show results from using a coil-shaped reactor according to this invention.

### DETAILED DESCRIPTION OF THE INVENTION

The present invention relates to a coil-shaped photocatalytic reactor which comprises (A) at least one coil-shaped sheet of polymeric support material having top and bottom portions and substantially coated with a photocatalyst, wherein the sheet of polymeric material is transparent to ultraviolet light and (B) a source of ultraviolet light which is transmitted through at least one sheet of the polymeric material.

The present invention also relates to a process for removing contaminants from water, wherein the process comprises moving water through a coil-shaped photocatalytic reactor which comprises (A) at least one coil-shaped sheet of polymeric support material having top and bottom portions and substantially coated with a photocatalyst, wherein the sheet of polymeric material is transparent to ultraviolet light and (B) a source of ultraviolet light which is transmitted through at least one sheet of the polymeric material.

The catalysts useful in this invention are those photocatalysts which function when deposited on a polymeric support material. Examples of those catalysts are:
TiO₂—titanium dioxide (titania)
ZnS—zinc sulfide
SrTiO₃—strontium titanium oxide
ZnO—zinc oxide
WO₃—tungsten(VI)oxide
CdS—cadmium sulfide
Fe₂O₃—iron(III)oxide
SnO₃tin(IV)oxide
Al₂O₃—aluminum oxide (alumina)

Preferred catalysts are TiO₂ and Al₂O₃.

Mixtures of two or more of these catalysts can be used.

In this invention, the catalysts are used in amounts necessary to achieve the objectives of specific applications. Some applications may require greater amounts of catalyst per unit area of support material than other applications.

In this invention, a useful polymeric support material should have good optical qualities; a convenient geometry for the catalytic reaction; provide for post-reaction separation of the composite catalytic material from the reactant solution; and strong surface bonding with the catalyst without decreasing the reactivity of the catalyst.

Preferably, the polymeric support material is lightweight, durable, cross-linked and resistant to chemical attack. Additionally, the support material should be transparent to the ultraviolet light which activates the photocatalyst.

Effective polymeric support materials for use in this invention include:
poly(vinyl acetate)
poly(vinyl chloride)
polyethylene terephthalate
acrylic polymers, such as poly(methyl methacrylate)
polystyrene
polyurethanes
polyepoxies
polycarbonates
polypropylene

For this invention, a preferred polymeric support material is an acrylic polymer, such as poly(methyl methacrylate).

The coil-shaped reactor of this invention preferably comprises one continuous sheet of polymeric support material substantially coated with a photocatalyst. However, other configurations can be used, such as a series of two or more sheets of polymeric support material with each sheet in the form of the letter “C”; or a series of two or more nested perforated tubes formed with the polymeric support material. In any configuration, the sheet or sheets of polymeric support material are substantially coated with a photocatalyst. In the coil-shaped reactor of this invention, two essential elements are that the water to be treated is exposed to multiple layers of photocatalyst-coated polymeric support material and that the ultraviolet light passes through the multiple layers.

The distance between the one or more coils can be varied, based on the requirements of the particular use. Similarly, the height and thickness of the one or more coils can be varied, depending on the particular use and related requirements.

Titania deposition on UV-transparent acrylic provides a durable, photocatalytically active composite material from which the coil-shaped reactor of this invention can be fabricated. A lightweight, low-cost, portable and highly efficient photocatalytic reactor can be constructed utilizing advances in photocatalyst deposition and illumination sources. In the coiled reactor geometry, light radiated from the center of the reactor which is not absorbed by titania in the first layer is allowed to pass though the acrylic support material and is available to potentially activate titania in any of the subsequent six layers. This approach maximizes the utilization of the illumination intensity available. As a demonstration of the effectiveness and flexibility of this reactor, contaminants including methyl orange (MO), methylene blue (MB), lead, and bacteria were removed from water using the coil-shaped reactor of this invention, with LED and CFL as the ultraviolet light sources.

The present invention is further illustrated by the following examples which are illustrative of certain embodiments that are designed to teach those of ordinary skill in this art how to practice this invention and to represent the best mode contemplated for carrying out this invention.

### Experimental Details

Materials. The titania powder (P-25) was provided by Degussa. The poly(methylmethacrylate) support material (acrylic) was 4.76 mm thick Acrylite OP-4 from Cyro Industries Dichloromethane (Spectrum), methanol (Fisher), methyl orange (Amend), methylene blue (Merck), and Pb (NO₃)₂ (Wards) were used as received. K12 Escherichia coli (Carolina) were cultured in LB broth (Carolina) before being centrifuged and washed three times, and then dispersed in 0.9% (w/v) aqueous NaCl solution prior to reactor testing. All water used was purified by a Millipore Milli-Q-A10 system and had a resistivity of 18.6 MΩcm A 250 mW UV-LED operating at 370 nm (Nichia model NCSU033A) was used with a 4.25 V DC power source. A 13 W (120 V AC (alternating current)) compact fluorescent “black light blue” light source (Sunbe-Lite) was also utilized.

Reactor Fabrication and Design. The reactor was constructed from a 114 cm×14 cm sheet of acrylic. At one end of the sheet, a 38 cm long section was masked off on, one side and the remainder of the sheet was sandblasted. The sandblasted sheet was then thoroughly cleaned with water and then methanol to remove any residue. A 0.48 mg/cm² layer of titania was then solvent deposited on both faces of the acrylic sheet excluding the previously masked surface. A mixture of methylene chloride and methanol was used as the deposition solvent. The resulting titania-acrylic composite sheet had a total titania-covered acrylic surface area of 2660 cm² with a total titania mass of 1.3 g.

The titania-acrylic composite sheet was then thermoformed by heating in an oven to 140° C. and then rolling the heated sheet into a coil using 3 mm thick neoprene sheets as spacers to separate the layers of the coil. The center of the spiral was wound around a 7 cm diameter cylinder to maintain an open reactor center for the insertion of the light sources (both LED and CFL). The outer diameter of the coil shaped reactor was 12.5 cm, and a 14 cm×14 cm baseplate was solvent welded to the reactor base providing a sturdy and water-tight bottom. At the end of the acrylic sheet (where the coil terminates), a vertical semicylindrical acrylic tube was solvent welded to make the reactor column water-tight and function as a reactor sampling reservoir. A separate reactor core/lid structure was fabricated for each light source.

The LED was mounted in one reactor lid with the direction of the illumination oriented downward with an angle of divergence of 120° within a sealed 3 cm diameter acrylic tube. Axially emitted light was then redirected radially outward by a 10 cm long aluminum cone mounted in the bottom of the 13 cm long acrylic tube. The LED was cooled during use by pumping the reactor solution through a 10 mL glass reservoir in thermal contact with the back of the LED. In this way, the LED was kept within optimal operating temperatures, and the reactor solution was modestly heated to increase reaction rates.

The CFL was inserted into a separate reactor core/lid that incorporated a 5 cm diameter acrylic tube that was also 13 cm long with a 4 cm diameter hemispherical aluminum reflector used to redirect light radially outward to the surrounding titania layers. The CFL itself was 9.5 cm long.

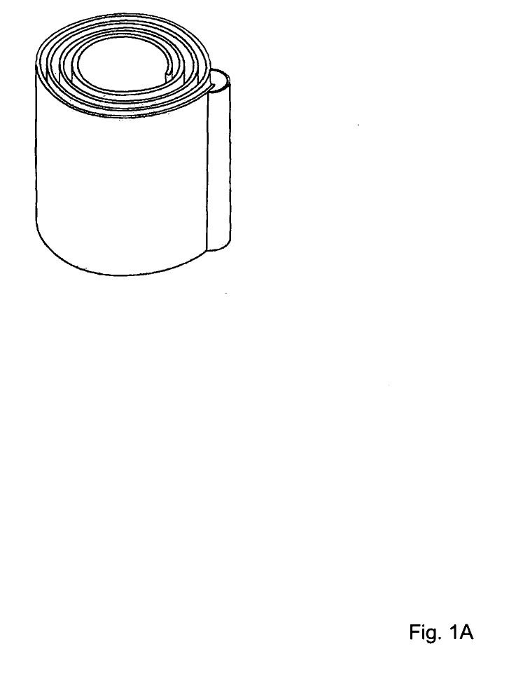

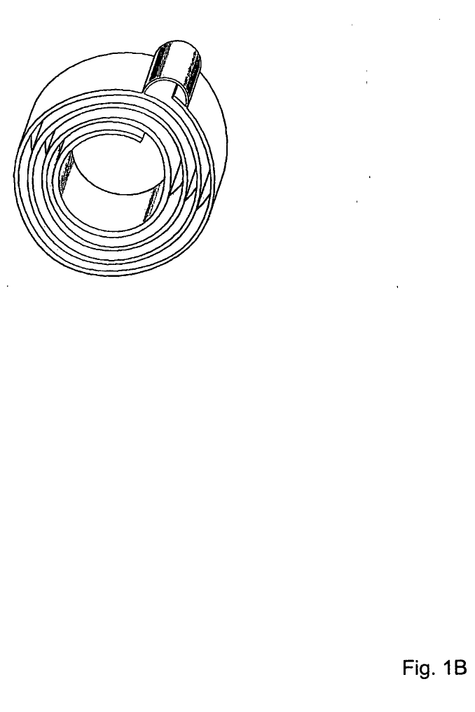

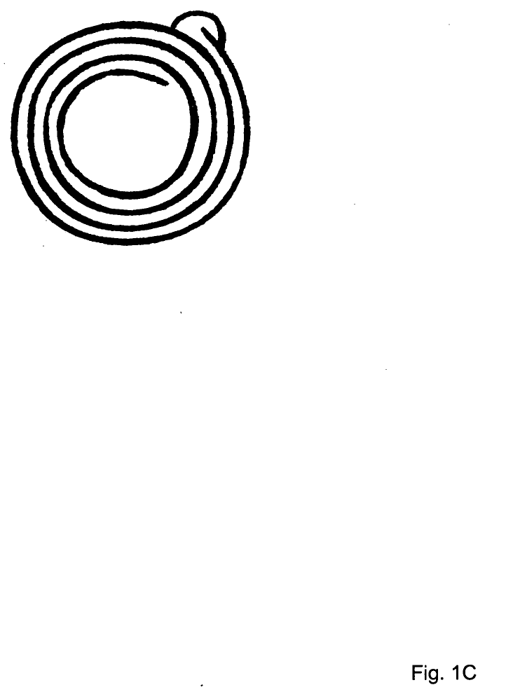

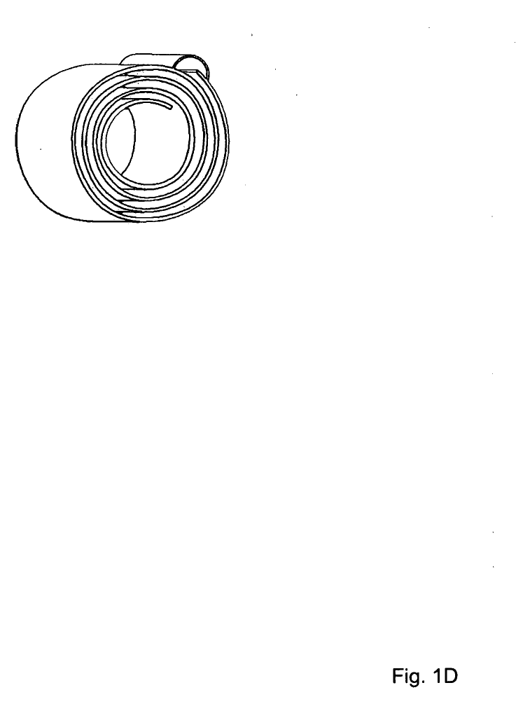

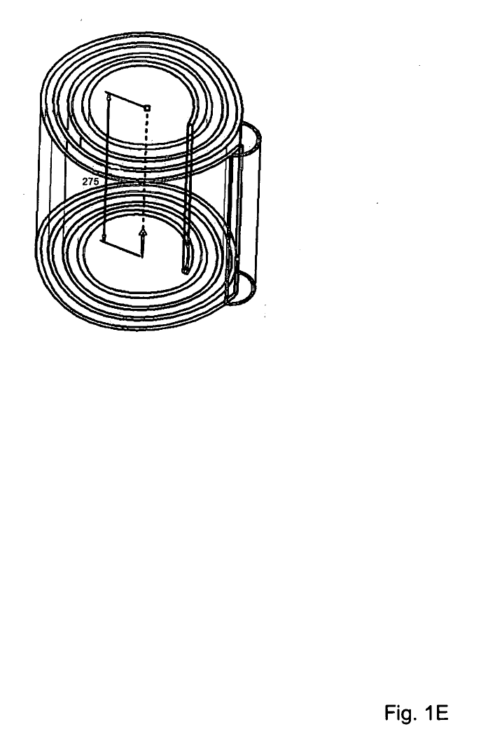

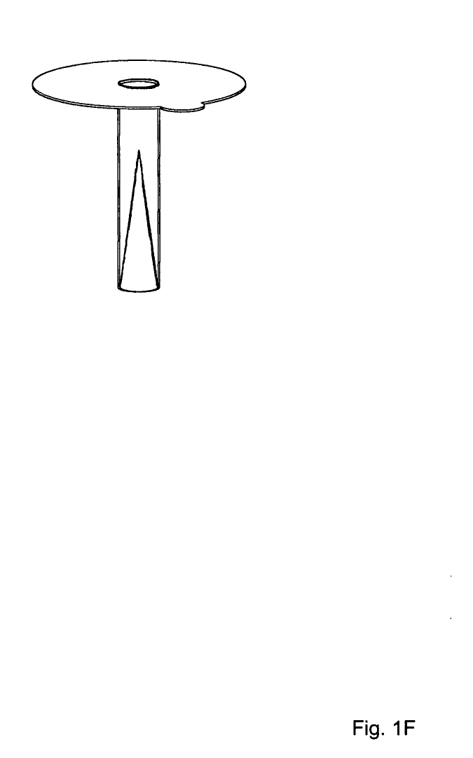

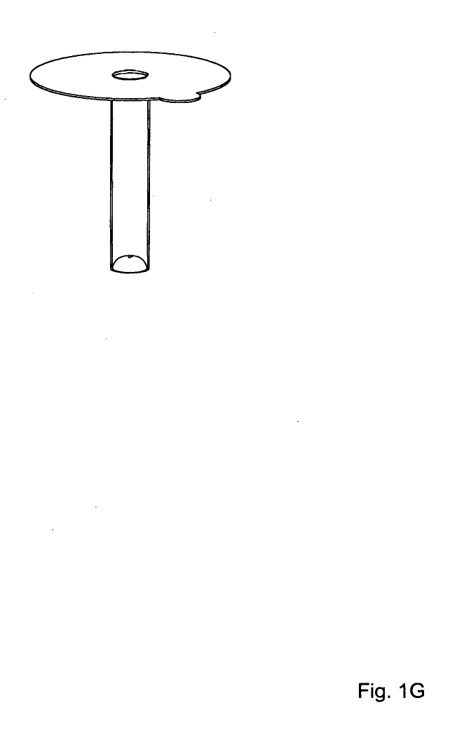

FIG. 1 shows diagrams of the reactor and the two reactor core/lid structures. The reactor volume was 800 mL with the LED core/lid in place and was reduced to 650 mL when the larger CFL core/lid was used. To completely exit the reactor, light from the source must travel through a total of seven titania layers as well as approximately 5 cm of reactor solution. The reactor was wrapped in an aluminum foil jacket to reflect unutilized light from the source back into the interior of the reactor. The surface area to volume ratio (titania surface area to solution volume) was 3.33 and 4.09 cm²/mL when the LED and CFL core/lids were used, respectively.

The reactor contents were circulated through the reactor by an external DC-powered pump with a flow rate of 3.6 mL/s. The water was pumped from the vertical semicylindrical column on the outside of the reactor through polypropylene tubing and returned through the lid of the reactor into the reactors interior core. The intake tubing was inserted to the bottom of the semicylindrical column and was perforated to remove the reactor solution uniformly from the entire depth of the reactor. In this manner the reactor contents were continuously recirculated through the reactor coil.

Methods. Spectral Data Collection. Spectra from both light sources and UV-vis spectra for MB and MO were collected on a StellarNet EPP2000 fiber optic spectrometer. Irradiance spectra were collected with a fiber-mounted cosine receptor (StellarNet model CR2). Cuvettes of 1 cm were used for the collection of all absorbance spectra. The absorbance of the MB solutions was determined at 662 nm whereas 463 nm was used for the detection of MO.

Illumination Intensity. The LED light source was used to probe the effect of illumination intensity upon the photocatalytic activity of a single titania layer. The irradiance on a 9 cm diameter titania-acrylic composite disk was varied by controlling the DC current through the LED. Controlling the DC current only affected the illumination intensity, and the spectral distribution was unaffected by changes in current. The illumination was provided perpendicular to the titania layer surface through the acrylic support without traversing the solution. An additional sand blasted acrylic diffuser was used to homogenize the illumination over the entire area of the titania-acrylic composite. A 50 mL sample of 20 ppm .MO was used, and samples were collected over a period of 0.5 h for spectroscopic detection of the MO concentration. The solution was contained in an 11 cm diameter cylindrical glass vessel and was constantly stirred with a magnetic stir bar throughout each experiment.

Organic Dye Degradation. Separate 10 ppm solutions of MB and MO were utilized in the coil reactor. A 1 cm flow cell was inserted into the flow loop external to the reactor to allow automated spectroscopic determination of the concentration of MB or MO in solution. The absorbance was measured every 2-5 min for a period of at least 2 h. To quantify the MB and MO degradation, the pseudo-first-order rate constants for their respective degradation were determined as the slope of the plot of In(C/C₀) as a function of time in minutes, where C is the concentration and C₀ is the initial concentration. Each experiment was performed in triplicate. Control experiments (light controls) were performed with each illumination source and each dye in a control reactor that was otherwise identical to the photocatalytic reactor except that the control reactor contained no photocatalyst. Additional control experiments (dark controls) were performed where the solutions were circulated through the titania-coated reactor with no illumination provided.

Microbiological Tests. E. coli suspensions in the range of 2000-4000 colony forming units per milliliter (CFU/mL) were introduced into the reactor and constantly recirculated throughout the experiment with the external pump. Triplicate 0.1 mL samples were collected periodically over a time frame of up to 420 min. These samples were immediately spread on agar plates and incubated for 24 hours at 37° C. The resulting colonies were manually counted. Both light sources were used for the microbiological tests, and both the light and dark controls were also performed.

Metal Deposition. A sample of 22 ppm Pb(NO₃)₂ was used as the source of aqueous Pb²⁺ with 5% (v/v) methanol present as an electron donor. Using the CFL as the illumination source, 650 mL of this solution was circulated through the reactor. Samples of 5 mL were collected periodically over a 24 hour period. The concentration of Pb in the solution was quantified spectrophotometrically with an atomic absorption spectrometer (Perkin-Elmer AAnalyst 100). Following the 24 hour photodeposition process, the reactor was emptied and the process was repeated for a total of six iterations.

After the sixth Pb deposition, the reactor was emptied and washed three times with 650 mL of 0.1 M HNO₃ in the dark for 3 hours each time. The concentration of Pb in these wash solutions was also quantified spectroscopically. The Pb recovery percentage was calculated from the cumulative mass of Pb that was removed from the reactor during the acid washes compared to the cumulative amount of Pb that was deposited in the six Pb depositions. The amount of Pb removed from the reactor at each sampling during the initial Pb deposition time study was accounted for in the calculation of the recovery percentage.

### Results and Discussion

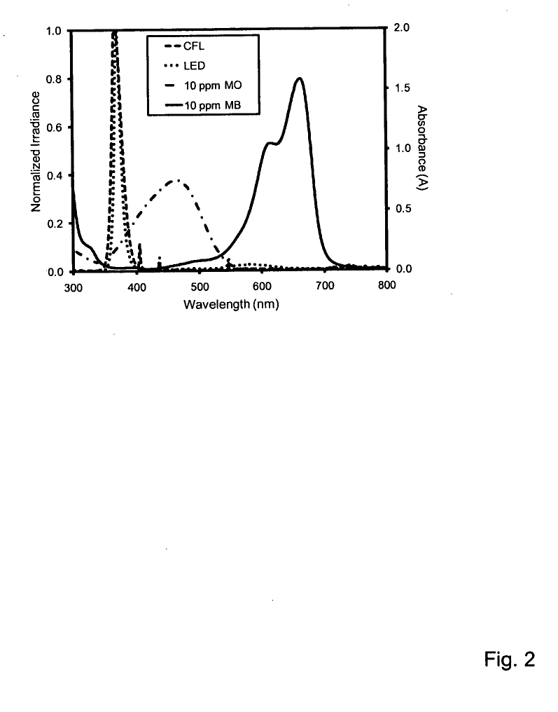

Spectral Data. The emission spectra of the two light sources are compared to the transmission spectra of MB and MO solutions in FIG. 2. The emission spectra of the two light sources are very similar with the CFL peaking at 366 nm and the LED peaking at 370 nm. The reliance of the coil reactor upon illumination through the solution makes the absorbance spectrum of the solution itself of the utmost importance.

There are two important factors involved when a solution component absorbs the ultraviolet excitation light. An absorbing component is more likely to undergo direct photolysis, but that comes at the expense of a decreased illumination intensity available for excitation of the titania. For this reason that both MB, largely transparent in the near-UV, and MO, with a considerable UV-A absorbance, were utilized for reactor characterization. At 370 nm and a 1 cm path length, the transmittance of 10 ppm MO is 63% and the transmittance of 10 ppm MB is 96%.

Illumination Intensity. To optimize the efficiency of a photocatalytic reactor system, it is important to maximize the utilization of the available illumination. The surface area to volume ratio for a given reactor is significant, but the importance of the illumination utilization cannot be ignored. The effect of varied illumination intensity upon the photocatalytic degradation of methyl orange was probed with a single layer of acrylic-supported titania.

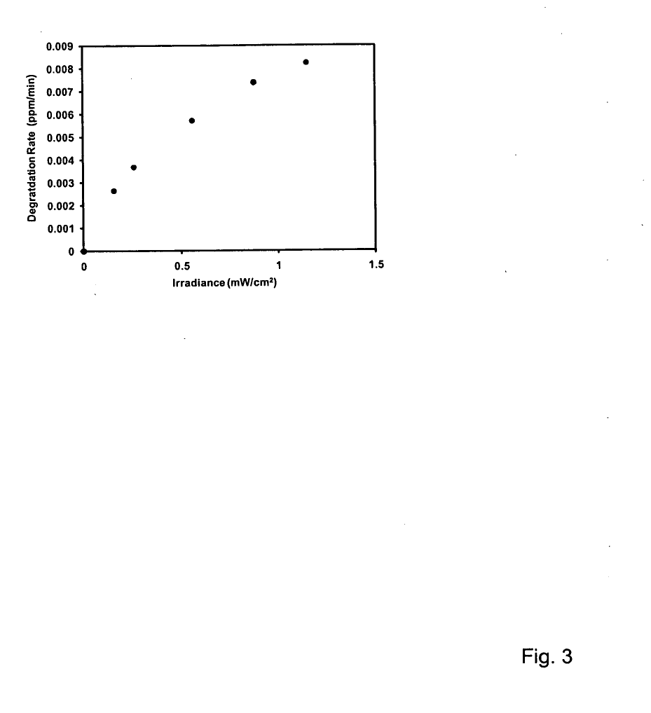

FIG. 3 shows the degradation rate of MO as a function of the applied illumination intensity. The logarithmic shape of this curve clearly emphasizes that even very low illumination intensities can result in significant photocatalytic activity. This reduction in photonic efficiency at high illumination intensities has been previously observed in other titania photocatalytic experiments.

A reference point from FIG. 3 is the comparison between the respective activities at irradiances of 1.0 and 0.5 mW/cm²: if an illumination source providing 1.0 mW/cm² of illumination could be modified to apply half of that intensity over twice the titania surface area, the result would be a total degradation rate of 0.19 ppm/min as compared to a degradation rate of 0.12 ppm/min.

A primary conclusion to be drawn from FIG. 3 is that it is not advantageous to discard excess illumination intensity. An optimized reactor design should incorporate a strategy to utilize the light that is transmitted through a titania film. Merely reflecting this light back onto the initial titania film is not as effective as allowing this illumination to be transferred to a larger titania surface area. Increasing the titania film thickness to absorb all of the light provided also does not resolve this issue, because this merely results in the generation of electron-hole pairs deep within the titania surface, where recombination is expected to dominate.

The coil reactor of this invention is designed to make maximum use of the illumination intensity available. As the light passes through the reactor, from the core to the exterior, the irradiance decreases as the surface area increases. The outer layers of the coil thus have low irradiance levels, but substantial titania surface area, and are able to contribute significantly to the overall photocatalytic activity of the reactor. The irradiance at the interior titania layer was determined to be 2.1 mW/cm² for the CFL source and 0.48 mW/cm² for the LED source in the absence of solution. The irradiance remaining at the exterior of the reactor with the aluminum jacket removed was 0.14 and 0.05 mW/cm² for the CFL and LED source, respectively.

This clearly indicates that even the outer layers of the coil reactors receive significant illumination intensity. Since the outer layer of the coil reactor possesses the largest surface area, this residual illumination, albeit small, would be expected to result in substantial photocatalytic activity as indicated by FIG. 3. The utilization of a single LED source for the illumination of the entire reactor results in a significant limitation in the irradiance of the titania. Multi-LED arrays arranged around a cylinder like “kernels of corn around the cob” have been used by other researchers. Such LED arrays could be easily integrated into the reactor design of this invention and would likely increase the reaction rates by increasing the available illumination intensity.

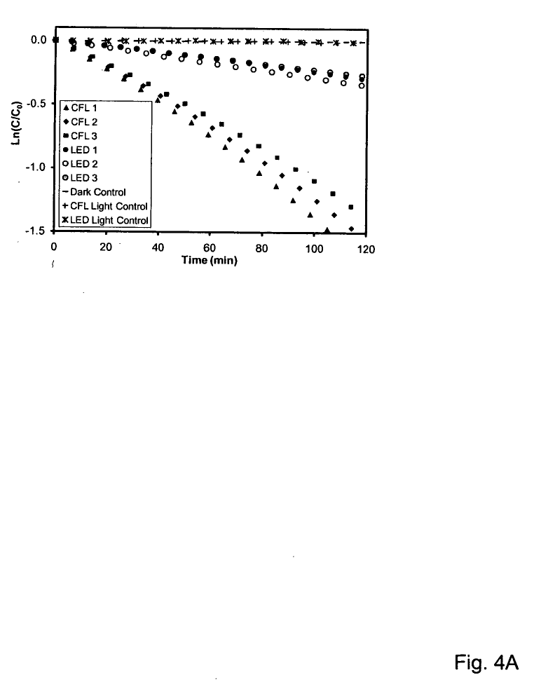

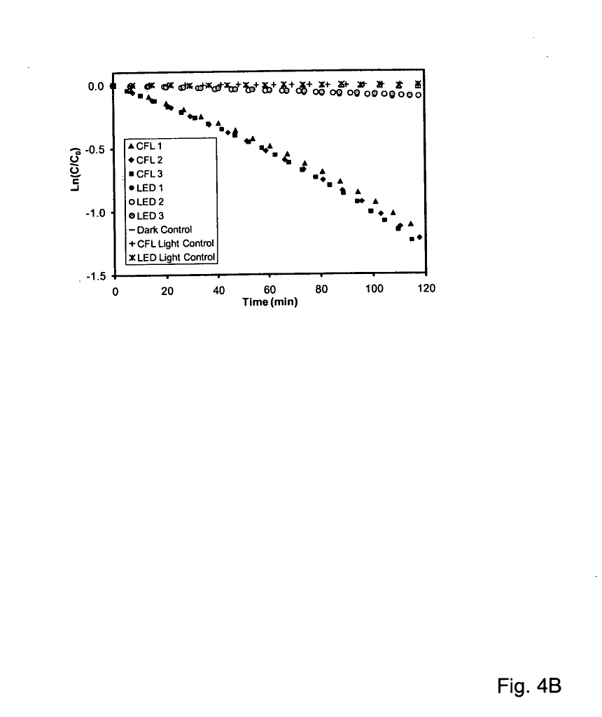

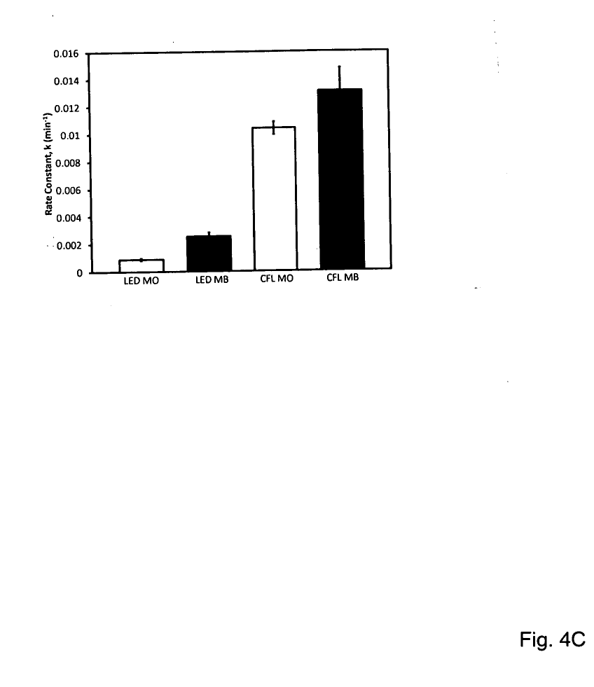

Organic Dye Degradation. FIG. 4 shows the photocatalytic degradation of 10 ppm MB and 10 ppm MO in the coil reactor utilizing both the CFL and the LED light sources. It is immediately clear that the degradation rates for both species are much faster with the CFL light source than with the LED light source. This is due to two contributing factors. The first is the drastically greater intensity of the CFL source, though it should be noted again that the volume of the reactor is decreased from 800 to 650 mL when the CFL light and accompanying reactor core are used. Thus, the comparison between the rates of the CFL and LED powered reactors is not of primary interest.

However, the comparison between the degradation rates of MO and MB is highly informative. The rate constant for MO degradation is 79% that of MB degradation when the CFL source is used, but is only 35% of the MB degradation rate when the LED source is utilized. The difference between these two ratios highlights the significance of the differences in the optical density of the MO and MB at the excitation wavelength. This difference in MB and MO degradation rates is enlarged when the illumination intensity is low. When the limiting factor for photocatalytic degradation is illumination intensity, the magnitude of the solution absorbance is extremely important. When the illumination intensity is larger and less of a limiting factor for the overall degradation rate, the absorbance of the solution is of much smaller importance.

The degradation of MO represents a difficult test case for the coil reactor design of this invention due to its considerable absorbance at 370 nm, but FIG. 4A indicates that even under low illumination conditions MO can be successfully degraded with the coil reactor design of this invention. The results of the dark and light control experiments shown in FIGS. 4B and 4C clearly demonstrate that the observed degradation of MO and MB by the illuminated coil reactor is due primarily to titania photocatalysis and not simply to dye adsorption or direct photolysis.

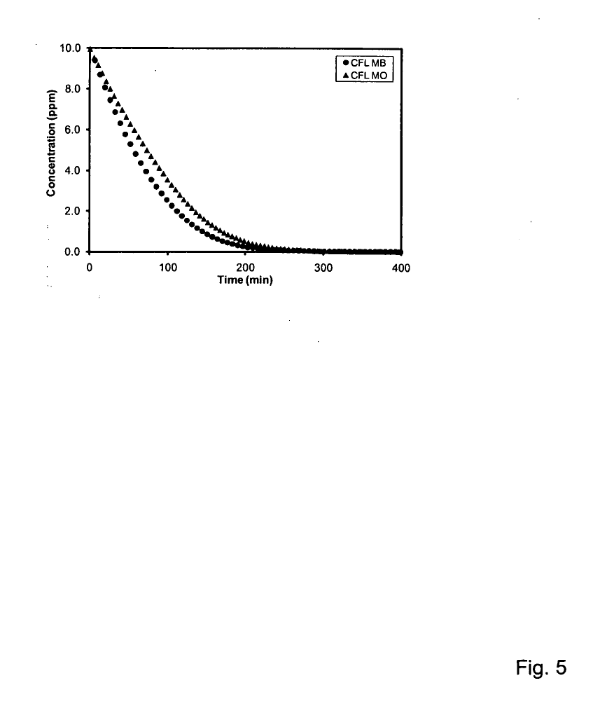

FIG. 5 demonstrates that both MO and MB can be completely and efficiently degraded in the coil-shaped reactors of this invention. This success is an important indicator of potential application-based success where complete degradation of the target species is often essential. Even the recalcitrant MO solution is completely degraded within 5 hours utilizing the coil reactor with the CFL source.

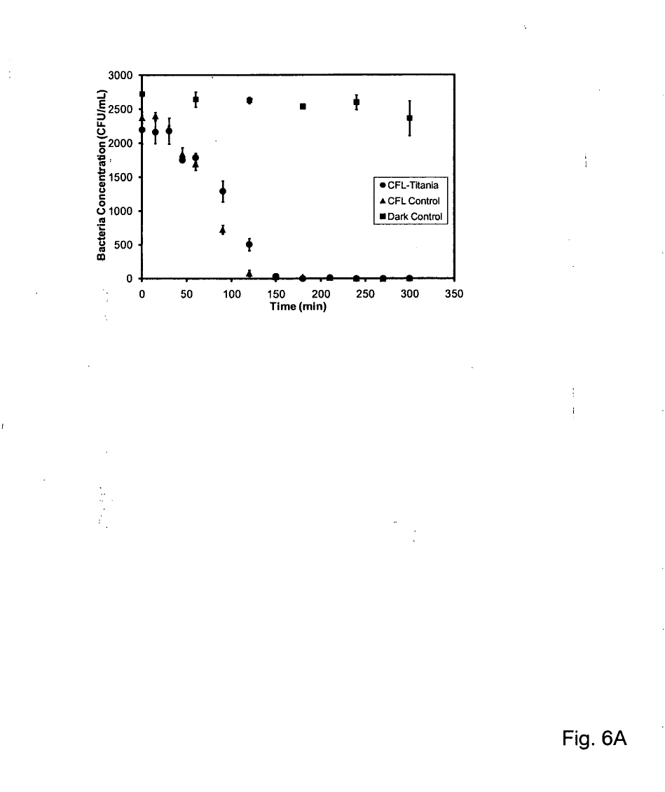

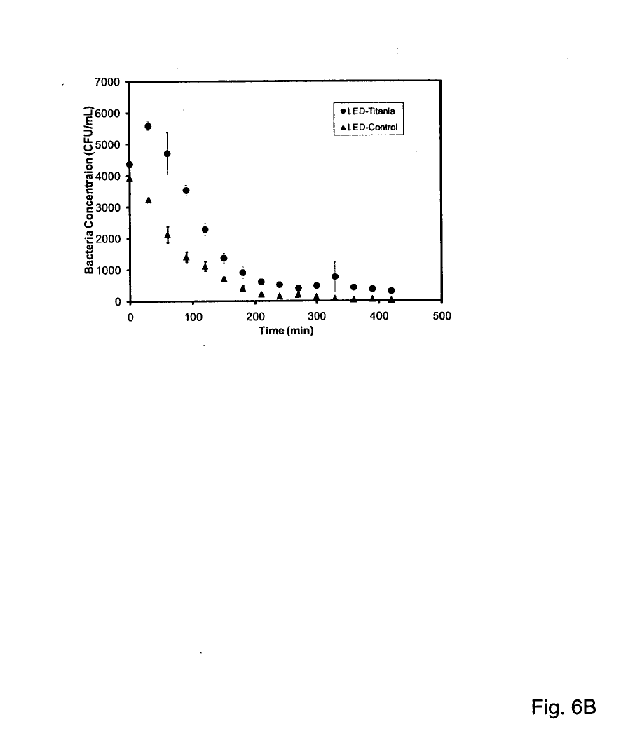

Microbiological Tests. The results of the bacterial inactivation experiments are shown in FIGS. 6A and 6B. The dark control experiment showed no bacterial inactivation within 5 hours (FIG. 6A), indicating that bacterial adsorption on the titania surface does not significantly contribute to the observed antibacterial activity. The bacteria show substantial sensitivity to the UV light source and are rapidly inactivated even without a photocatalytic contribution from the titania. In fact, the presence of the titania within the reactor has the effect of slightly slowing the sterilization process, particularly with the lower-intensity LED source (FIG. 6B). It is believed that this is due to the absorption by the titania of the UV light that can otherwise be involved in direct sterilization of bacteria.

The lower sterilization rate shown by the reactor using LED illumination in FIG. 6B (with and without titania) as compared to the sterilization rate of the reactor with the CFL source shown in FIG. 6A is again somewhat complicated by the differing reactor volumes required when the different light sources were used. Thus, a direct comparison of inactivation rates between FIGS. 6A and 6B is not of significant interest.

However, the fact that presence of the titania on the reactor surface had a much greater impact when the LED source was used does serve to further underscore the importance of the illumination intensity upon the coil reactor performance. When the more intense CFL source was used (FIG. 6A), the negative effect of the light absorption by the titania was minimized, and sterilization occurred at around 150 min regardless of the presence of the photocatalyst. The sterilization rate was more adversely affected by the presence of the titania when the illumination intensity was lower (FIG. 6B) using the LED source.

Clearly, if the primary objective of the reactor is water sterilization, the titania is of no direct benefit when these light sources are used. However, if the objective is the broader purification of water including organic, metallic and microbiological components, the photocatalytic activity of the titania is invaluable. The presence of the titania has only a modest impact on the sterilization rate with the coil reactor using the CFL source, and the photocatalytic activity of the titania is capable of removing metallic and organic components from the water as well.

It has also been reported that titania photocatalysis is capable of not only inactivating bacteria but also completely mineralizing the cellular components of the dead bacteria, as well as degrading bacterial toxins present. The slight decrease in sterilization rate is more than compensated for by this ability to perform broad-based purification.

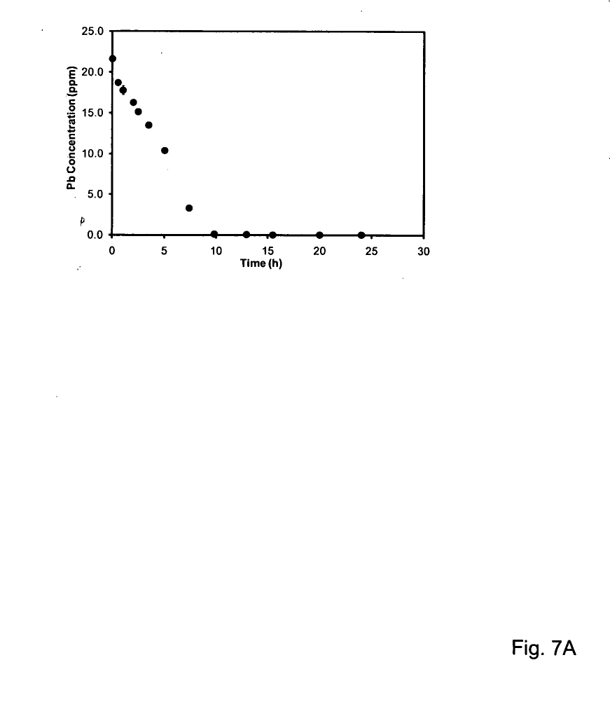

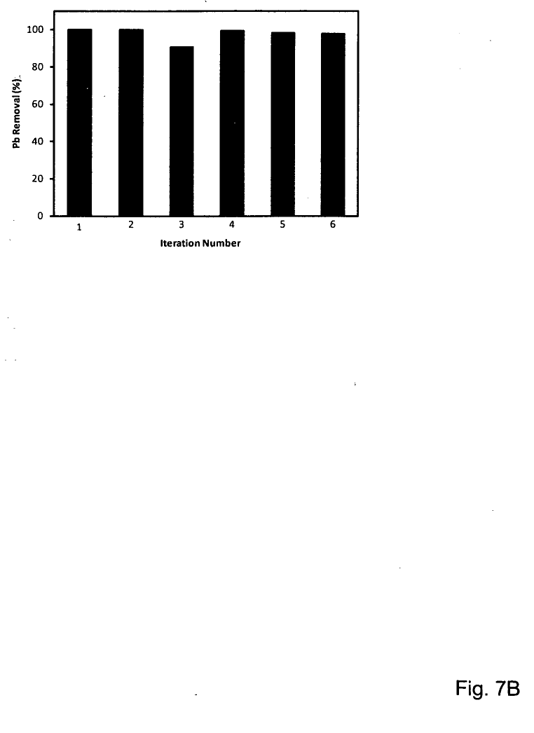

Metal Deposition. The Pb in 650 mL of a 22 ppm Pb solution was completely photodeposited on the surface of the reactor within 10 hours of illumination using the CFL source, as shown in FIG. 7A. The ability of the reactor to continue to pull Pb from aqueous solution was probed by the repetition of this process six times. The mass percentage of the Pb removed from each of these six iterations is shown in FIG. 7B. It is clear that the capacity of the reactor for Pb removal has not been exceeded within these six iterations. The maximum capacity of the reactor for Pb removal was not investigated, but the total mass of Pb removed in the six iterations exceeds 84 mg. Considering that the USEPA action limit for Pb in drinking water is 15 ppb and that typical Pb contamination in drinking water is in the parts per billion range, this amount of Pb removal is likely sufficient for the purification of many thousands of liters of water.

The extraction of the Pb from the reactor surface following Pb photodeposition was accomplished using three consecutive 0.1 M nitric acid washes. These three washes removed 92.6%, 3.2%, and 0.2%, respectively, of the Pb deposited on the surface for a total Pb recovery of 96%. Unexpectedly, the removal of the Pb from the reactor surface with the dilute HNO₃ resulted in the partial loss of titania from the acrylic surface as observed by solution turbidity and the visible loss of titania from the reactor surface itself.

This decomposition of the titania layer on the surface of the acrylic is not due exclusively to the action of the HNO₃ on the titania or on the acrylic since no titania removal was observed when 0.1 M and even 1.0 M HNO₃ solutions were allowed to stand in the reactor for 3-6 hour intervals in the absence of photodeposited Pb. The HNO₃ was only observed to remove titania from the titania-acrylic composite when Pb had been previously deposited on the titania surface.

The explanation for this phenomenon is not certain. However, each individual titania nanoparticle is not necessarily bound to the acrylic surface. Instead, SEM micrographs indicate that multiparticle agglomerates are each fused to the acrylic surface during the solvent deposition process. It is likely that the decomposition of the titania surface occurs when photodeposited Pb bridges adjacent titania particles, overcoming the van der Waals forces binding the individual particles together into agglomerates.

The subsequent removal of the Pb from the titania surface could then be expected to disintegrate the titania agglomerates, leaving only the primary titania layer firmly bound to the acrylic support. Although the photocatalytic activity of the coil reactor is not affected by hundreds of hours of general use, the removal of titania that accompanies the acid recovery of the Pb resulted in a 40% decrease in the pseudo-first-order rate constant for methyl orange degradation (from 10.4×10⁻³ min⁻¹ prior to Pb removal to 6.3×10⁻³ min⁻¹ after the titania loss accompanying Pb removal).

This indicates that although the coil-shaped reactors of this invention can be acid washed to remove photodeposited metals, significant activity losses can be expected following this procedure. Due to the low cost of the titania.-acrylic composite materials, it could be preferable to treat the reactor body as disposable after significant metal deposition has occurred rather than reusing a reactor that has been acid washed to extract photodeposited metal from the reactor. The illumination source and the recirculation pump could be reused when the titania-coated reactor body is replaced.

### SUMMARY

The coil-shaped reactor used in this investigation showed no change in performance throughout the course of the experimentation with the exception of that caused by the Pb deposition and subsequent acid washing procedure. This reactor durability is consistent with previous reports using titania-acrylic composite materials for over 1100 hours without loss of photocatalytic activity. The lightweight and rugged acrylic construction of the coil-shaped reactor combined with the pH stability of the titania-acrylic composite allow this reactor to be utilized for portable or fixed-base applications where the ability to remove organic, metallic, and bacterial contaminants is desired. The removal and/or degradation of these contaminants occurs on similar time scales making the total purification of contaminated water feasible. Furthermore, metal-modified titania could be utilized with this coil-shaped reactor, allowing the utilization of visible light. The ongoing development of this reactor configuration should involve the investigation of external (solar) illumination and the use of multiple coil reactors in series for single-pass, on-demand water purification.

Although described with specific reference to the treatment of water, the coil-shaped reactor of this invention can also be used in non-aqueous applications, such as the purification of gas phase systems. For example, this reactor can be used to oxidize carbon monoxide to carbon dioxide.

The present invention has been described in detail with particular reference to certain embodiments, but variation and modification can be made without departing from the spirit and scope of the invention as defined in the following claims.

This work was funded in part by a grant (No. BW-0044) from The Welch Foundation.

1. A coil-shaped photocatalytic reactor comprising:
A. at least one coil-shaped sheet of polymeric support material having top and bottom portions and substantially coated with a photocatalyst, wherein the sheet of polymeric material is transparent to ultraviolet light; and
B. a source of ultraviolet light which is transmitted through at least one sheet of the polymeric material.

2. A reactor as defined by claim 1 wherein the polymeric support material is an acrylic material.

3. A reactor as defined by claim 2 wherein the acrylic material is poly(methylmethacrylate).

4. A reactor as defined by claim 1 wherein the polymeric support material is selected from the group consisting of poly(vinyl acetate), poly(vinyl chloride), polyethylene terephthalate, acrylics, polystyrene, polyurethanes, polyepoxies, polycarbonates and polypropylene.

5. A reactor as defined by claim 1 wherein the sheet of polymeric support material has a height of at least about 114 cm and a thickness of at least about 14 cm.

6. A reactor as defined by claim 1 wherein the photocatalyst is selected from the group consisting of titanium dioxide, zinc sulfide, strontium titanium oxide, zinc oxide, tungsten(VI)oxide, cadmium sulfide, iron(III)oxide, tin(IV)oxide and aluminum oxide.

7. A reactor as defined by claim 1 wherein the photocatalyst is aluminum oxide.

8. A reactor as defined by claim 1 wherein the photocatalyst is titanium dioxide.

9. A reactor as defined by claim 1 wherein the source of ultraviolet light is an ultraviolet light emitting diode.

10. A reactor as defined by claim 1 wherein the source of ultraviolet light is a compact fluorescent blacklight.

11. A process for the removal of contaminants from water, wherein the process comprises moving the water through a coil-shaped photocatalytic reactor which comprises:
A. at least one coil-shaped sheet of polymeric support material having top and bottom portions and substantially coated with a photocatalyst, wherein the sheet of polymeric material is transparent to ultraviolet light; and
B. a source of ultraviolet light which is transmitted through at least one sheet of the polymeric material.

12. A process as defined by claim 11 wherein the polymeric support material is an acrylic material.

13. A process as defined by claim 12 wherein the acrylic material is poly(methylmethacrylate).

14. A process as defined by claim 11 wherein the polymeric support material is selected from the group consisting of poly(vinyl acetate), poly(vinyl chloride), polyethylene terephthalate, acrylics, polystyrene, polyurethanes, polyepoxies, polycarbonates and polypropylene.

15. A process as defined by claim 11 wherein the sheet of polymeric support material has a height of at least about 114 cm and a thickness of at least about 14 cm.

16. A process as defined by claim 11 wherein the photocatalyst is selected from the group consisting of titanium dioxide, zinc sulfide, strontium titanium oxide, zinc oxide, tungsten(VI)oxide, cadmium sulfide, iron(III)oxide, tin(IV)oxide and aluminum oxide.

17. A process as defined by claim 11 wherein the photocatalyst is aluminum oxide.

18. A process as defined by claim 11 wherein the photocatalyst is titanium dioxide.

19. A process as defined by claim 11 wherein the source of ultraviolet light is an ultraviolet light emitting diode.

20. A process as defined by claim 11 wherein the source of ultraviolet light is a compact fluorescent blacklight.
